(19) United States
(12) Patent Application Publication
(10) Pub. No.: US 2008/0086458 A1
(43) Pub. Date: Apr. 10, 2008

(54) SOCIAL INTERACTION TAGGING

(75) Inventors: Merle Michael Robinson, Redmond, WA (US); Eric James Hennings, Seattle, WA (US)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: ICEBREAKER, INC., (KY)

(21) Appl. No.: 11/855,924

(22) Filed: Sep. 14, 2007

Related U.S. Application Data
(60) Provisional application No. 60/825,851, filed on Sep. 15, 2006.

(51) Int. Cl. G06F 7/00

(52) U.S. Cl. 707/3

(57) ABSTRACT

Systems (and corresponding methods) that enable use of tagging technology and tag management within a social networking environment are disclosed. These tags can include words, phrases, symbols, pictures, audio clips, video clips or the like. The innovation enables ‘snag-a-tag’ functionality whereby users can ‘snag’ (or copy) tags from other user's profiles. Still further, the innovation provides for tag ‘clustering’ where most any algorithm can be employed to relate tags within the environment. The innovation can also provide for identification of ‘common’ as well as ‘unique’ tags which refer to tags in common to or unique within a defined list of profiles.

### CROSS-REFERENCE TO RELATED APPLICATIONS

This application claims the benefit of U.S. Provisional Patent application Ser. No. 60/825,851 entitled ‘MOBILE SOCIAL NETWORK’, filed on Sep. 15, 2006 and is related to Serial No. entitled ‘MOBILE SOCIAL NETWORK’, filed on Jul. 10, 2006, and to U.S. patent application Ser. No. ______ entitled ‘SOCIAL INTERACTION MESSAGING AND NOTIFICATION’, filed on ______, and to U.S. patent application Ser. No. ______ entitled ‘SOCIAL INTERACTION GAMES AND ACTIVITIES’, filed on ______, and to U.S. patent application Ser. No. ______, entitled ‘LOCATION-BASED SOCIAL INTERACTION NETWORK’, filed on ______, and to U.S. patent application No. entitled ‘DATE MANAGEMENT WITHIN A SOCIAL INTERACTION NETWORK’, filed on ______. The entireties of the above-noted applications are incorporated by reference herein.

### BACKGROUND

The Internet continues to make available ever-increasing amounts of information which can be stored in databases and accessed therefrom. Additionally, with the proliferation of portable terminals (e.g., notebook computers, cellular telephones, personal data assistants (PDAs), smart-phones and other similar communication devices), users are becoming more mobile, and hence, more reliant upon information accessible via the Internet. Accordingly, the connectivity available via the Internet is frequently used to chat, socialize and communicate with friends and family.

One particular area in which the Internet is becoming popular is in the field of Internet dating and other social interaction services generally. An Internet dating service, or online dating, allows people to meet and get acquainted online thereafter potentially engaging in a romantic relationship. Conventional dating services are oftentimes moderated by a third party who matches candidates based upon criteria and/or preferences.

These online dating services enable a user to create a profile which can contain information relating to physical as well as personal characteristics. As well, these online dating services enable a user to search profiles of other candidates in order to locate a match based upon a predetermined set of criterion. For example, a user can search upon physical characteristics such as age, height, weight, hair color, etc. As well, personal characteristics such as income, interests, hobbies, religion, etc. can be used to search profiles.

Online dating or Internet dating continues to expand in popularity as more and more people become acquainted with the Internet and its vast communication resources. Effectively, the seemingly anonymity of the Internet alleviates much of the apprehension and pressures associated with face-to-face communication felt by many individuals.

In general, online dating services operate by the same criteria as typical relationships. However, factors specific to the nature of online communications may affect the experience. There are many positive factors that can inherently enhance the online experience. For example, online dating sites facilitate individuals to meet more people than they would without such sites. As well, online matchmaking sites enable individuals to easily browse other members' profiles before deciding to initiate communication.

Essentially, these online dating services enable users to break down geographic barriers while enabling users or members to learn more about a prospect or candidate before actually expending the time and effort to pursue a meeting. In today's busy society, the value added by the ability to pre-screen candidates is very desirable.

Conventional dating services have begun to migrate into today's mobile society. More particularly, recent developments have been directed to employing matchmaking services via mobile devices such as cell phones, smartphones, etc. However, because these conventional mobile systems are nothing more than a mobile version of the traditional Internet dating systems, they have been plagued with slow response time, widespread deception and lack of interactivity.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems (and corresponding methods) that enable tag management within a social networking environment. In a particular aspect, the innovation enables the use of tags to effect pairings within the social network environment. In aspects, these tags can include words, phrases, symbols, pictures, audio clips, video clips or the like. Still further, the tags can be classified as ‘community’ tags or ‘certified’ tags among others.

In other aspects, the innovation enables ‘snag-a-tag’ functionality whereby users can ‘snag’ tags from other user's profiles. In these aspects, users can select which tags to snag from a list. The list can be configured in most any fashion including but, not limited to, alphabetical, numbered, etc. Additionally, the list can be equipped with radio buttons and/or checkboxes to assist in ease of selection.

Still further, the innovation provides for tag ‘clustering.’ As used herein, clustering can refer to most any algorithm of relating tags within the environment. Similarly, the innovation can provide for identification of ‘common’ as well as ‘unique’ tags. ‘Common’ tags refer to tags in common to a defined list of profiles. On the other hand, ‘unique’ tags refer to those tags that are unique to a defined list of profiles.

Still further, the innovation provides for the use of ‘certified’ tags—which require some type of authorization prior to use. Accordingly, aspects disclose the use of a certification component to effect such authorization thereby enabling the use of a certified tag.

In yet other aspects thereof, rules-based logic or machine learning & reasoning (MLR) components are provided that employ probabilistic and/or statistical-based analysis to infer an action that a user desires to be automatically performed. For example, MLR can be employed to automatically snag-a-tag on behalf of a user.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates tag management in a social matching environment in accordance with an aspect of the innovation.

FIG. 2 illustrates an example flow chart of procedures that facilitate snagging a tag in accordance with an aspect of the innovation.

FIG. 3 illustrates an example flow chart of procedures that facilitate clustering tags in accordance with an aspect of the innovation.

FIG. 4 illustrates an example block diagram of a communication system that enables profile and tag query in accordance with an aspect of the innovation.

FIG. 5 illustrates an example block diagram of a tag management component that facilitates locating and selecting tags in accordance with an aspect of the innovation.

FIG. 6 illustrates an example block diagram of a tag selection component that enables snag-a-tag, tag clustering, common tag identification, unique tag identification, and tag certification in accordance with an aspects of the innovation.

FIG. 7 illustrates example snag-a-tag screen layouts in accordance with an aspect of the innovation.

FIG. 8 illustrates an example communication system diagram that employs rules-based and/or machine learning & reasoning logic to automate one or more features of the innovation.

FIG. 9 is a schematic block diagram of a portable handheld device according to one aspect of the subject innovation.

FIG. 10 illustrates an example screen view of a profile screen in accordance with an aspect of the innovation.

FIG. 11 illustrates an example screen view of a snag-a-tag screen in accordance with an aspect of the innovation.

FIG. 12 illustrates a block diagram of a computer operable to execute the disclosed tag management architecture.

FIG. 13 illustrates a schematic block diagram of an example computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms ‘component’ and ‘system’ are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to ‘infer’ or ‘inference’ refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

While certain ways of displaying information to users are shown and described with respect to certain figures as screenshots, those skilled in the relevant art will recognize that various other alternatives can be employed. The terms ‘screen,’ ‘display,’ ‘web page,’ and ‘page’ are generally used interchangeably herein. The pages or screens are stored and/or transmitted as display descriptions, as graphical user interfaces, or by other methods of depicting information on a screen (whether personal computer, mobile telephone, or other suitable device, for example) where the layout and information or content to be displayed on the page is stored in memory, database, or another storage facility. Similarly, the information can be dynamically modified in accordance with a particular device as available or desired.

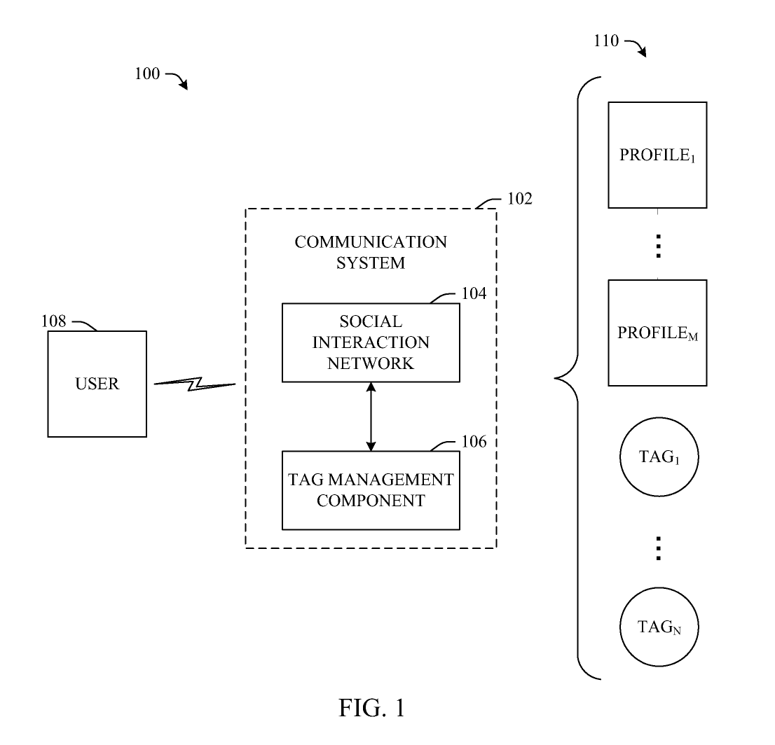

Referring initially to FIG. 1, the subject innovation is directed to a system 100 (and associated methods) that facilitates tag management in connection with a social interaction system. Here, the innovation proposes uses of tags and tagging methodologies to enhance the ability to search (and be searched) within a social networking environment. In other words, users can select tags that identify characteristics, attributes, interests, slogans, descriptions, etc. These tags can be used by the system in order to associate or connect users via search mechanisms (e.g., queries).

Generally, system 100 can include a communication system 102 that comprises a social interaction network 104 and a tag management component 106. Together, these components (104, 106) enable the user 108 to access 1 to M profiles and/or 1 to N tags, where M and N are integers. Essentially, the system 100 enables members of a social interaction network 104 to employ tags to query, search, or locate, other members that are described by tags of interest to the user 108.

The social interaction component 104 enables many of the core functionalities of a social interaction service. For instance, the social interaction component 104 can maintain user/member profiles, contact information, preferences, policies, etc. In other words, the social interaction component 104 can provide mechanisms and means for users to locate each other by browsing tags which include personal characteristics, interests, locations, preferences, etc. of other users, members or subscribers. The tag management component 106 facilitates location, selection and/or application of tags within the system 100.

Conventionally, users of Internet or mobile dating services typically search through databases of users by physical features, limited personal attributes (e.g., age and income) and behaviors (e.g., smoker). These searches create an unhealthy environment based on sometimes harsh, judgmental searches. For instance, many users are overlooked due to a perceived inferior physical feature, personal attribute or behavior—e.g., men under 5′10′ in height, men with an income under a certain threshold, or older single mothers.

The innovation exposes a somewhat more interesting way to create an integrated community by promoting searches based upon personality characteristics, description or ‘tags.’ A tag can be a user defined word or short phrase that helps define them, e.g., outgoing, talkative, pets, or even Elvis. In aspects, these individually generated tags can then be used by other members of the community—‘community tags.’

Alternatively, some tags may be off-limits to members unless the user is ‘certified’ to use it. For example, some users may want to legitimately establish his personal connection to a university, e.g., University of Pittsburgh, the educational institution, with the tag, ‘PITT’. Certified tags could be used to establish the validity of claims made by a user (such as their marital status, age, height, income, location of primary residence, degrees or professional certification achieved, employment or former employment at a particular company, participation in a particular financial or business transactions or a set thereof, establishment of a particular ‘reputation’ or ‘rating’ such as an ecommerce seller rating, etc.).

In this example, if the PITT tag was available on a dating site, the site could potentially only allow certified students or alumni to use that tag within their profile and/or upon searching or querying candidate profiles. The management of such certified tags, including the possibility of segmenting the users into sub-communities by certified tags will be described in greater detail with reference to the figures that follow.

While many of the examples are directed to social networking services, it is to be understood that the technology can be applicable to a wide variety of applications and environments where one set of users wants to be able to trust assertions made by other users. By way of illustration, and not limitation, examples include job searching, advertisement of professional services, ecommerce, verification of age of people submitting user generated content, etc. These and other conceivable uses of the features, functions and benefits of the innovation are to be included within the scope of the innovation and claims appended hereto.

The innovation proposes improvements to uses of community tags within the social networking realm. As will be understood upon a review of the description and figures that follow, the innovation discloses mechanisms by which tags can be utilized in a powerful, comprehensive and versatile manner. One such example is dubbed herein as ‘snag-a-tag’ functionality. Overall, this ‘snag-a-tag’ technology makes it easy for users to find and apply tags while casually browsing content. As will be understood, the features, functionalities and benefits of the snag-a-tag innovation provide significant benefits to people who are ‘snagging’ the tags, people whose tags are snagged and people who browse using the tags.

People whose tags are snagged effectively end up sharing more of their tags with other users. For instance, they benefit by having more visitors find their content (e.g., profile) while browsing a commonly shared tag. This benefit can be very important for Internet networking systems (e.g., mobile dating services) because, in the dating space, more profile views generally correlate to more potential dates. People who snag tags have an easier time finding and applying appropriate tags. Similarly, browsers can benefit by having a longer browsing experience for the tags in which they have the most interest.

Still further, the technology disclosed herein also provides particular benefits to users of mobile technology who want to add tags to their content. More particularly, mobile users often encounter a painful experience by struggling to type in tags on a limited or tiny keypad. Additionally, mobile device inserted tags are often misspelled, which essentially renders the tag useless. If, instead, the mobile phone users only typed in a small percentage of tags because they easily ‘snag’ the rest from other users, they could have a much more enjoyable experience. Their need to type is decreased considerably. In one example, tags can be snagged by simply entering a corresponding numeric value from a list of related, common, clustered, relevant or community tags.

The ‘snagging’ technology can be very powerful in a slightly different usage for ecommerce users. Here, in user-created product listings (e.g., popular auction sites/services), each seller would like to maximize the number of visitors landing at their page. In accordance with the innovation, users can search for the same product or similar products, and thereafter ‘snag’ or copy all the tags into their own listing. Thus, for this scenario, the feature would be called ‘Snag-the-tags’ rather than ‘snag-a-tag.’

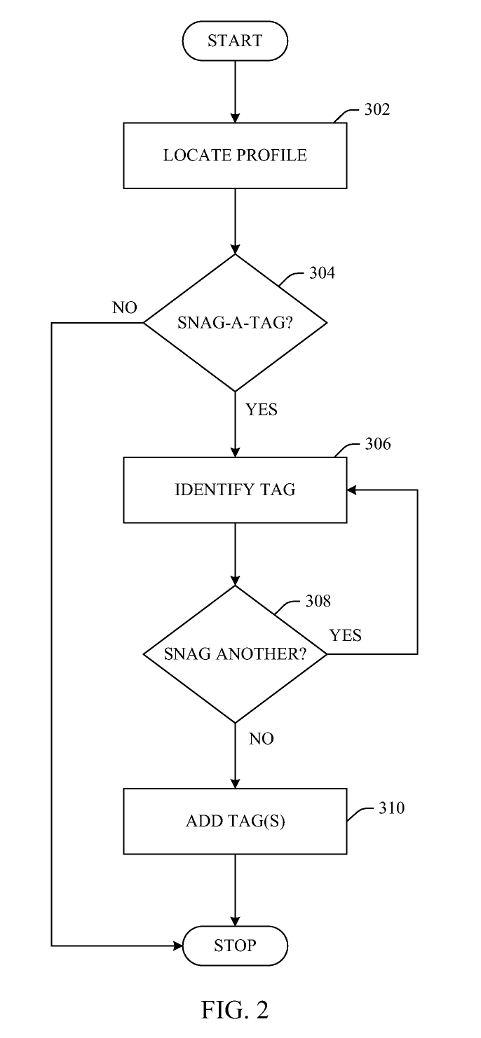

FIG. 2 illustrates a methodology of snagging a tag (or group of tags) in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 302, a profile of a candidate can be located. Here, the profile can be located based upon most any search or query mechanism. Once a profile is located, at 304, a determination can be made if a tag of a located candidate is desired to be snagged. In other words, a determination is made to decide if the user desires to copy a tag (or group of tags) from the located candidate profile.

If the user does not desire to retain any of the candidate's tags, the methodology ends. However, if a tag is desired to be ‘snagged’ (or copied), the particular tag can be identified at 306. Next, a determination can be made at 308 to identify if another tag is desired to be snagged.

As shown, if another tag is desired, the methodology returns to 306 where an additional tag can be identified. It is to be understood that this process is recursive and can repeat for as many tags as desired. Once a determination is made that no additional tags are desired to be snagged, the tags can be added to the user profile at 310. It is to be understood that, although the methodology of FIG. 2 employs a tag batching-type system, in alternative aspects, tags can be added to the user profile as they are identified.

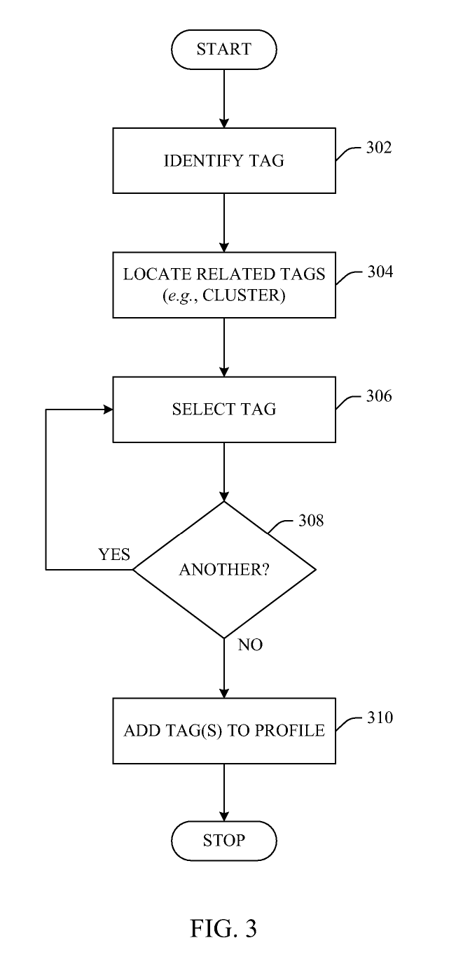

FIG. 3 illustrates a methodology of the clustering tags in accordance with an aspect of the innovation. At 302, a tag is identified—for example, by locating a candidate profile and thereafter selecting a tag. In another aspect, a tag can be entered free-form by a user. For instance, a user can enter a tag such as ‘Pittsburgh Steelers.’

At 304, related tags are located and returned to the user. For example, both community tags as well as certified tags can be located and returned for consideration by the user. This act can also be referred to as ‘tag clustering’ whereby logic is employed to identify related tags. Continuing with the ‘Pittsburgh Steelers’ example above, at 304, tags such as ‘football,’ ‘sports,’ etc. can be identified. It is to be understood that the located tags can be located by way of a social network database (e.g., previously used tags) or alternatively, can include tags for consideration that have not yet been employed by any member or user of the network.

At 306, a tag can be selected for addition to the user profile. A determination is made at 308 to decide if another tag is desired. If so, the methodology returns to 306 to select another tag. However, if another tag is not desired, the methodology proceeds to 310 whereby tags can be added to a user profile (e.g., snagged).

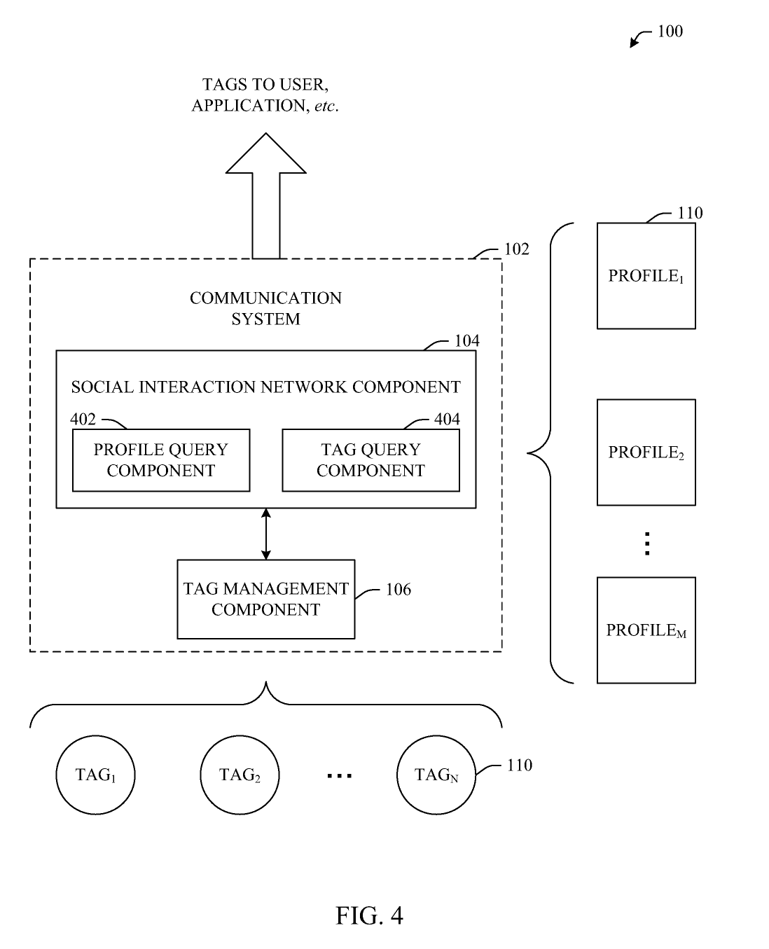

Turning now to FIG. 4, an alternative example block diagram of system 100 is shown. As shown, social interaction network component 104 can include a profile query component 402 and a tag query component 404. As described with reference to the preceding methodologies, a user can search profiles (e.g., via profile query component 402) or tags (e.g., via tag query component) in order to prompt snag-a-tag, clustering, common tag identification, etc.

Essentially, a user can define a profile query via the profile query component 402. Accordingly, profiles that meet the query criteria can be identified and returned. Similarly, the tag query component 404 can be used to establish a search for specific tags. In either case, tags are returned, either included within candidate profiles or alone. The tag management component 106 can be used to select an identified tag for incorporation into a user profile. This functionality will be described in greater detail upon a review of the figures that follow.

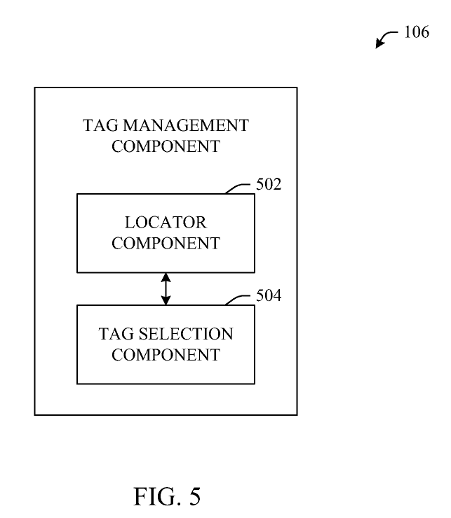

FIG. 5 illustrates an example block diagram of a tag management component 106. As shown, the tag management component 106 can include a locator component 502 and a tag selection component 504 that enable rendering available tags to a user and effecting selection thereof. As described above, these subcomponents can facilitate snag-a-tag, clustering, common tag identification, etc.

In addition to extracting tags from returned profiles, the locator component 502 can employ other sophisticated logic and/or rules to identify alternative related tags. For example, tags can be indexed and interrelated such that any tag can be mapped to a number of related tags. In aspects, it is to be understood that correction algorithms can be employed to correct for alternate or misspelled tags. Most any logic and/or indexing mechanisms can be employed to locate appropriate tags for consideration.

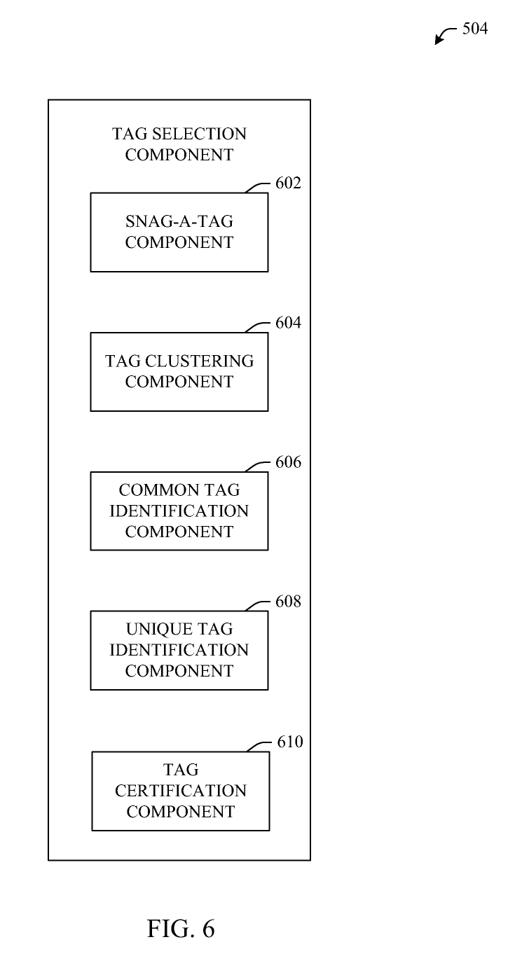

The tag selection component 504 can employ most any mechanism conceivable to effect user selection in response to tag consideration. As well, sophisticated logic such as rules-based, artificial intelligence, machine learning & reasoning, etc. can be employed to make decisions on behalf of a user. A more detailed example tag selection component 504 is shown in FIG. 6 that follows.

Referring now to FIG. 6, an example tag selection component 504 is shown in accordance with an aspect of the innovation. While five individual sub-components are illustrated inclusive of the tag selection component 504, it is to be understood that any subset of the illustrated sub-components can be employed in accordance with alternative embodiments.

As shown in FIG. 6, the tag selection component can include a snag-a-tag component 602 that, as described supra, enables a user to snag-a-tag (or copy) from a rendered tag list or tags within a list of rendered profiles. The tag selection component 504 can also include a tag clustering component 604, a common tag identification component 606, a unique tag identification component 608 and/or a tag certification component 610. Each of these components will be described in greater detail infra.

In addition to snag-a-tag functionality, the innovation discloses extensions to community tags by way of tag clustering and automatic common tag detection. Community tags can be defined as groups of symbols (e.g., shapes, letters and/or numbers), single words or short phrases that are used to help describe a user (or candidate) to the rest of the community. In aspects, the usable set of community tags (or library) is established and maintained jointly by members of the community. In other words, once a tag is created, other users can easily find the tag and add it to their own profile (e.g., by way of snag-a-tag functionality).

By way of example, a user might like music, and specifically Elvis. That user would then add the word ‘music’ to his/her tags. He would probably also add ‘Elvis,’ and might even add ‘rock and roll.’ A tag query component (e.g., 404 of FIG. 4) can be employed to search the entire community for tags. Additionally, as described above, one can search for users that only have specific tags (e.g., via profile query component 402 of FIG. 4). Also users can search by a combination of other user characteristics and, simultaneously, by a specific set of tags. Users can also randomly browse through the user base using tags—for example by clicking to the ‘next’ profile with the tag Elvis.

The tag clustering component 604 enables tags to be linked based upon similarity or other defined criteria. Here, a user can optionally define a set of rules by which similar tags will be clustered. In aspects, certain tags can be clustered because of their ability to extend the search results to a larger set of similar results. For example, users searching under ‘Elvis’ might also be interested in searching under ‘rock and roll.’ When conducting searches for any tag, or set of tags, the tag clustering component 604 can automatically provide a list of related tags. The user can then add these tags to the search to ensure a better chance of finding the best match. Alternatively, the user can just click on one of the other tags and search on that tag instead.

The common tag identification component 606 can be employed to render tags in common to a defined set of profiles or preferred matches. As the user searches and identifies matches (or candidates), the service can determine common tags within the returned matches. For example, the tag selection component 504 can advise a user with a message such as ‘your matches have the following tags in common: Elvis, music . . . ’ Accordingly, the user will be given the ability to choose among those tags for subsequent searches. As well, these selected tags (as well as those from the clustering scenario) can be snagged as described with reference to the snag-a-tag functionality.

The unique tag identification component 608 enables a shift in conventional philosophy of selecting candidates. In addition to determining the tags that are in common within the preferred matches, the service (via the unique tag identification component 608) can also identify the most unique tags among the common tags. Here, it is to be understood that ‘unique’ can be defined as either uniquely used tags within searches or uniquely used tags within profiles. By conducting unique searches or by searching for users with unique profiles, users will be encouraged to avoid overwhelming popular users. This scenario will also create a cultural shift towards individuality, and away from common judgmental searches of most conventional social networking services.

As described above, the system can employ certified tags that are reserved for specific uses (e.g., via tag certification component 610). For example, in a dating service, users might want to identify themselves as alumni of a particular school (e.g., PITT). The dating service could restrict usage of that tag to those members that can certify that they are alumni. One way of doing this might be through email. Here, an alumnus of PITT could submit their PITT.edu email address and wait for a confirmation code to be sent to that email address. The service would then request entry of the confirmation code to confirm certification. Another type of certification could be through a sponsorship. Here, a company could pay for a pre-specified subset of users to have a particular certified tag. It is to be understood that other examples exist that employ the core functionality of the tag certification as described herein. These alternative aspects are to be included within the scope of this disclosure and claims appended hereto. For example, many other certification mechanisms could be applied including knowledge of a particular pin or code, offline authentication, background checks, phone callback, access to a particular website, inclusion in an organization's directory, etc.

Once a user has been certified, a next concern is differentiating certified tags from other community tags. Here, the service could select a common pattern to differentiate. In one embodiment, certified tags could be presented in a different font or a different color. These tags could have particular icons associated with them, they could follow a particular textual pattern, for example, they could contain the URL (uniform resource locator) or domain name for the organization. Additionally, the tags could link to an Internet page that provides information about the organization. There are many patterns that could differentiate certified tags. As such, it is to be understood that the aforementioned examples are provided merely to add perspective to the innovation and are not intended to limit the innovation in any manner.

Certified tags can also be used to segment a community. For example, in a dating service, the service could prevent any user that is not certified as PITT from viewing profiles from certified PITT users. In this way, services can divide their greater community into safe, enclosed sub-communities. These sub-communities can enhance ability to locate candidates with similar interests and affiliations.

Referring again to the tag clustering component 604, if a user enters tags for their profile, the application could cluster and thereafter recommend similar tags. For example, someone about to enter ‘rock and roll’ as a tag might be notified that this tag clusters with ‘rock music.’ If the clustering also indicated that ‘rock music’ is a more popular tag, then the user may end up picking ‘rock music’ because it will help more visitors to browse to their profile. This could be very powerful in a dating application where the number of potential dates is generally proportional to the number of users visiting your profile.

As described above, once a tag is entered, it can be used by the rest of the community. For example, another Elvis fan can search through the tags, find Elvis, and add the tag to his/her profile. An interesting way to enable that capability is through the ‘snag-a-tag’ technology of the snag-a-tag component 602. The general philosophy for ‘snag-a-tag’ is for a user to copy tags from others to their own profile in a very easy way. A potential scenario would be for a user to see a profile with a desired tag while browsing, and, in as few as one or two steps, the user can employ the snag-a-tag component 602 to copy the desired tag to their profile. Once the user completes the process, the tag is immediately part of their profile going forward.

The following scenarios are provided to add perspective to the innovation and are not intended to limit the innovation in any way. A first scenario is directed to a mobile WAP (wireless application protocol) experience. Since most mobile phones have a limited keypad and screen, the ‘snag-a-tag’ experience can be designed to be simple and easy to use. In one scenario, a user can browse through content, e.g., dating profiles. Eventually they would come across a profile that has a tag they desire. By clicking ‘snag-a-tag,’ or some similar link, they would then be taken to a screen where all the viewed profile's tags are shown. By clicking on any one of those tags, the user would immediately add that tag to their profile.

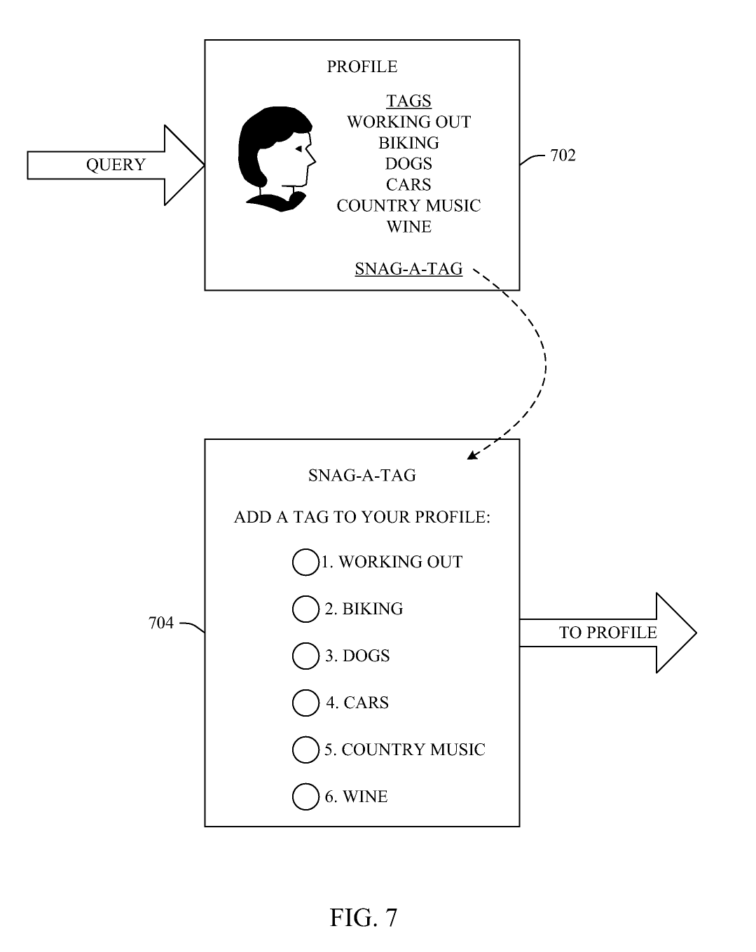

FIG. 7 illustrates an example page with reference to the snag-a-tag functionality. As illustrated, a query can render a profile 702 having a number of tags (e.g., working out, biking . . . ). In the event a user desires to copy any subset of the tags, the user can select the ‘snag-a-tag’ link on the profile page. This link will automatically launch a page 704 that reveals all of the available tags.

As can be seen in the example of FIG. 7, the sample screen 704 can include radio buttons as well as numbered choices to make selection easy and efficient for users, particularly mobile users. In particular, users that employ cellular phones or smart-phones can use a standard keyboard to select the matching numeric choice when a tag is desired. Similarly, if a touch screen is available, a user can simply click the radio button next to a desired tag (or group of tags). Thereafter, these selected tags can be automatically added to a user's profile.

With a full computer keyboard and large screen, the experience could potentially be made more powerful. While the mobile experience could be easily implemented in exactly the same way on a personal computer (PC), there are other options. For example, as the user clicks through profiles, the profile tags might always be available for snagging. In this example, the user could just click, drag and drop the tags into a ‘snag a tag’ bucket somewhere on the screen at anytime. Another possibility is that if the user clicks ‘snag a tag,’ or some similar link, any tag that is clicked thereafter would be ‘snagged’ until some event (either a timeout would occur or a some link was clicked that indicated an end to the ‘snagging’ session).

If users snagged tags freely, there could be some potential errors. For example tag limits may be imposed due to storage concerns. It will be appreciated that some sites could have limits on the number of tags allowed. In this case, the service could simply advise status (e.g., nearing quota, quota full) while potentially preventing more tags from being added. For example, in the mobile experience, the user would see a page letting him/her know that they had reached their limit. The page could also display the current set of tags, encouraging the user to remove one (or more) by clicking on it. For the advanced PC interface, the screen could continuously display the user's complete list of tags, letting the user know when they reached their limit. At that point, the user could remove any unwanted tags by dragging and dropping or by clicking.

If a user attempts to snag a certified tag without being certified, the service could either prevent the action with some explanatory message or let the user ‘apply’ for certification. The application would depend on the method of certification. Continuing with the PITT certification example above, the innovation could simply request user's PITT.edu email address to effect certification. Thus, a confirmation code would be sent as described above. If the certification process is successful, the tag would be added as expected.

In another scenario, a user may want to copy all the tags of another user. For example, when a user wants to post a new product for sale on an ecommerce site, his/her main goal is to have as many potential buyers view the post as possible. A potential technique would be to have the same tags for the product as other postings with the same or similar products. Thus, visitors would have a high probability of browsing their way to the new posting from previous postings.

‘Snag the tags’ would be an easy way for a new poster to use the same tags as others. In the example above, a user could type in the name of his product (or some other identifier such as an ISBN (international standard book number). The service could then suggest matching products. At that point, the user could ‘Snag the tags’ from related products through a simple link next to each product. In another embodiment, a user could be permitted to ‘snag’ all the tags of similar products by clicking on checkboxes next to each item before clicking ‘snag-the-tags’ of all check-boxed items. The service would then copy all tags to the new posted item, deleting duplicate tags in the process.

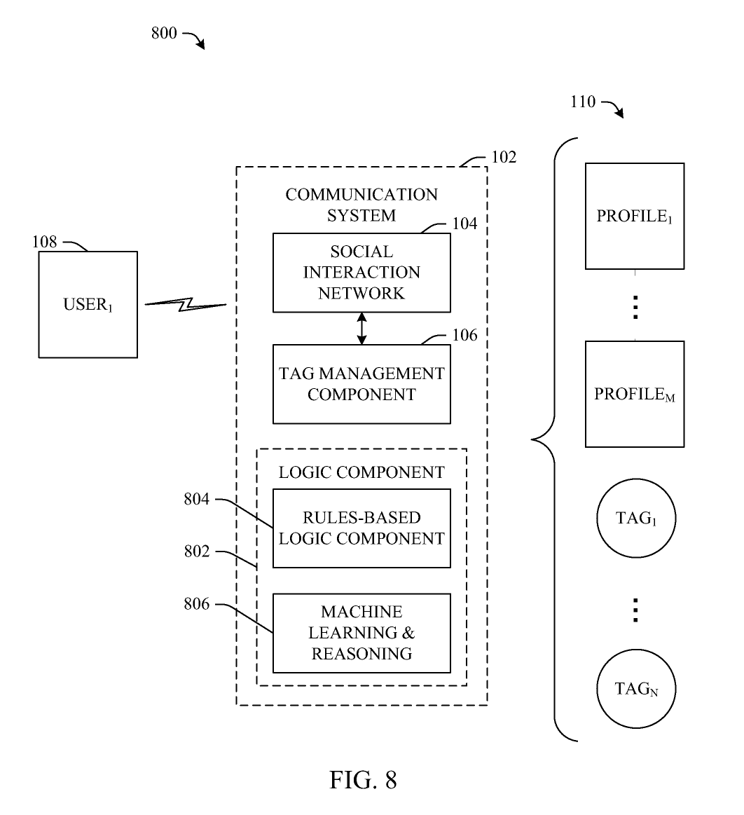

Turning now to FIG. 8, an alternative block diagram of an example system 800 that facilitates automatic tag management is shown. Generally, communication system 102 includes a logic component 802 that can employ policies and feedback in making decisions on behalf of a user with regard to managing tags. As shown, the logic component 802 can include a rules-based logic component 804 and/or an MLR component 806, each of which will be described in greater detail below.

As illustrated, communication system component 102 can include a rules-based logic component 802 that facilitates preference, policy and other user configuration features. In accordance with this alternate aspect, an implementation scheme (e.g., rule) can be applied, for example, to define and/or implement a query, to cluster relevant tags, etc. In other words, the rule-based implementation can select tags by employing a predefined and/or programmed rule(s) (or thresholds) based upon most any desired criteria (e.g., personalization, popularity, relevance, interest, utility).

In another aspect, MLR logic component 806 can be employed to automate one or more functions of the communication system 102. For instance, the innovation can employ MLR mechanisms in connection with tag management. The subject innovation (e.g., in connection with selection of profiles, tags, clustering, etc.) can employ various MLR-based schemes for carrying out various aspects thereof. For example, a process for determining tag clustering, common tag identification, tag selection, etc. can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when to deliver select a profile, when to relate tags, how to cluster tags, etc.

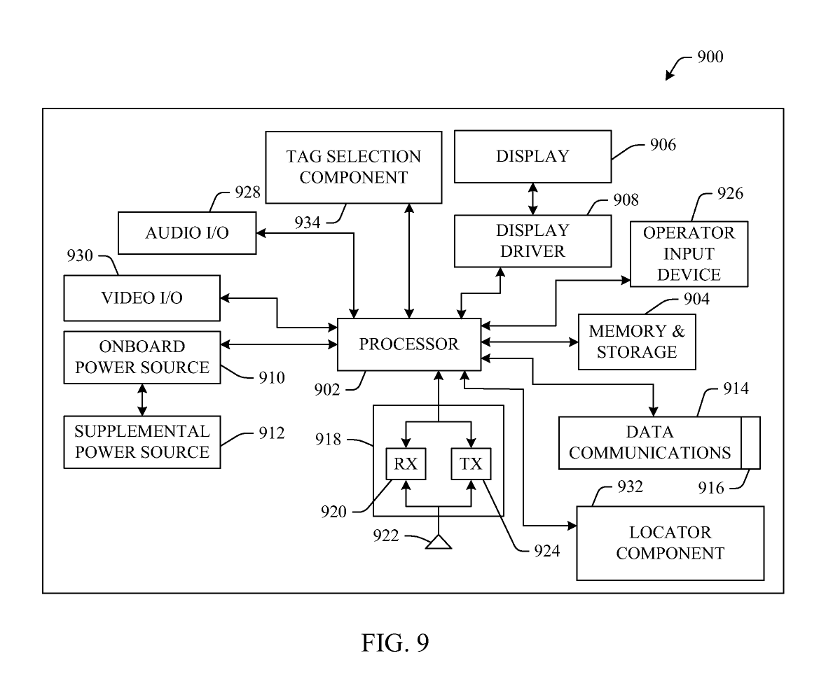

Referring now to FIG. 9, there is illustrated a schematic block diagram of a portable hand-held device 900 that can communication with a social interaction network component according to one aspect of the subject invention, in which a processor 902 is responsible for controlling the general operation of the device 900. The processor 902 can be programmed to control and operate the various components within the device 900 in order to carry out the various novel functions described herein. The processor 902 can be any of a plurality of suitable processors. The manner in which the processor 902 can be programmed to carry out the functions relating to the subject innovation will be readily apparent to those having ordinary skill in the art based on the description provided herein. As described in greater detail supra, rules-based logic and/or MLR components can be used to effect an automatic action (and sophisticated decision-making) of processor 902.

A memory and storage component 904 connected to the processor 902 serves to store program code executed by the processor 902, and also serves as a storage means for maintaining information such as data, services, metadata, device states, electronic mail messages, or the like. The memory 904 can be a non-volatile memory suitably adapted to store at least a complete set of the information that is acquired. Thus, the memory 904 can include a RAM or flash memory for high-speed access by the processor 902 and/or a mass storage memory, e.g., a micro drive capable of storing gigabytes of data that comprises text, images, audio, and video content. According to one aspect, the memory 904 has sufficient storage capacity to store multiple sets of information relating to disparate services, and the processor 902 could include a program for alternating or cycling between various sets of information corresponding to disparate services.

A display 906 can be coupled to the processor 902 via a display driver system 908. The display 906 can be a color liquid crystal display (LCD), plasma display, touch screen display or the like. In one example, the display 906 is a touch screen display. The display 906 functions to present data, graphics, or other information content via a UI. Additionally, the display 906 can display a variety of functions that control the execution of the device 900. For example, in a touch screen example, the display 906 can display touch selection buttons. In operation, when the notifications and/or messages are delivered, the UI, via display 906, can effectively convey the notifications and/or messages to a user. As described above, these notifications and/or messages can be text, pictures, visual, video, audio or combinations thereof.

Power can be provided to the processor 902 and other components forming the hand-held device 900 by an onboard power system 910 (e.g., a battery pack). In the event that the power system 910 fails or becomes disconnected from the device 900, a supplemental power source 912 can be employed to provide power to the processor 902 (and other components (e.g., image capture device)) and to charge the onboard power system 910. The processor 902 of the device 900 can induce a sleep mode to reduce the current draw upon detection of an anticipated power failure.

The device 900 includes a communication subsystem 914 having a data communication port 916, which is employed to interface the processor 902 with a remote computer, server, service, or the like. The port 916 can include at least one of Universal Serial Bus (USB) and IEEE 1394 serial communications capabilities. Other technologies can also be included, but are not limited to, for example, infrared communication utilizing an infrared data port, Bluetooth™, wireless protocols, etc.

The device 900 can also include a transceiver section 918 in operative communication with the processor 902. The transceiver section 918 includes a receiver 920, which receives signals from a remote device via an antenna 922 and can process the signal to obtain digital information therein. The transceiver section 918 also includes a transmitter 924 for transmitting information (e.g., data, service) to a remote device, for example, in response to manual user input via a operator input 926 (e.g., a keypad).

The transceiver section 918 facilitates communication with other portable devices and/or host computer systems. In furtherance thereof, an audio I/O section 928 is provided as controlled by the processor 902 to process voice input from a microphone (or similar audio input device) and can transmit audio output signals (from a speaker or similar audio output device).

In another implementation, the device 900 can provide speech recognition capabilities such that when the device 900 is used as a voice activated device, the processor 902 can facilitate high-speed conversion of the voice signals into text or operative commands. For example, the converted voice signals can be used to control the device 900 in lieu of using manual entry via the keypad 926. As well, in another aspect, voice commands can be employed to effect coupling and/or decoupling from a remote system. Still further, voice activated commands can be employed to snag tags, cluster tags, etc. Most any appropriate functionality of the innovation can be controlled via voice commands.

Similarly, video signals can be input and/or output via the video I/O component 930. The video I/O component 930 can include an image capture device capable of providing video communications (e.g., video chat) via the mobile device 900.

Other components such as a locator component 932 and tag selection component 934 can be provided within the housing of the device 900 to effectuate functionality described supra. For example, the locator component 932 can be employed in connection with querying and clustering tags. The tag selection component 934 can be employed to choose (manually or automatically) tags to ‘snag’ and thereafter apply to a user profile.

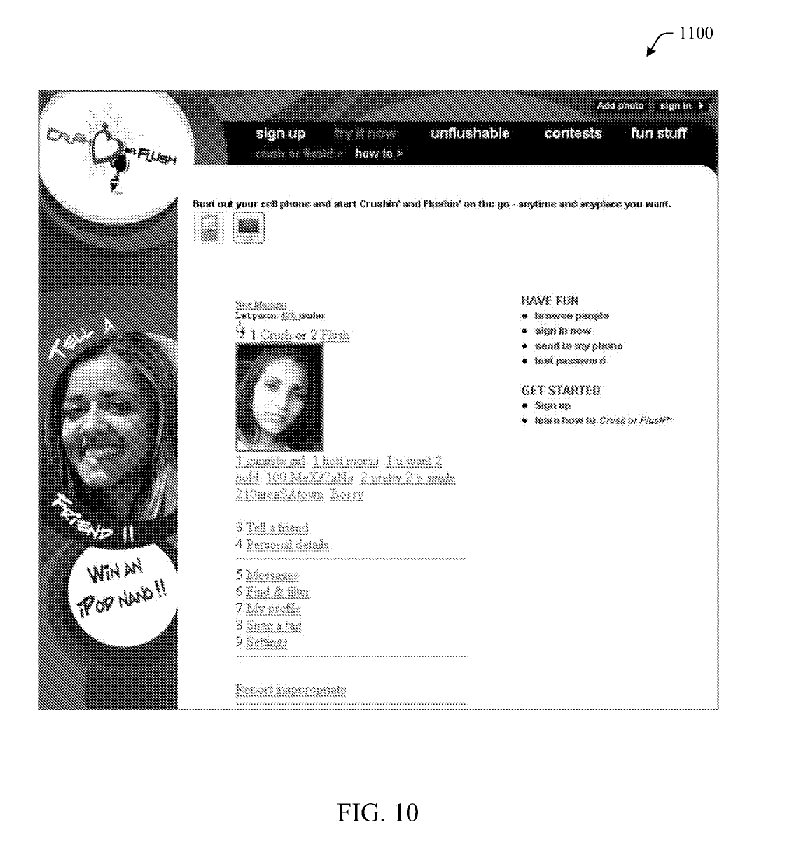

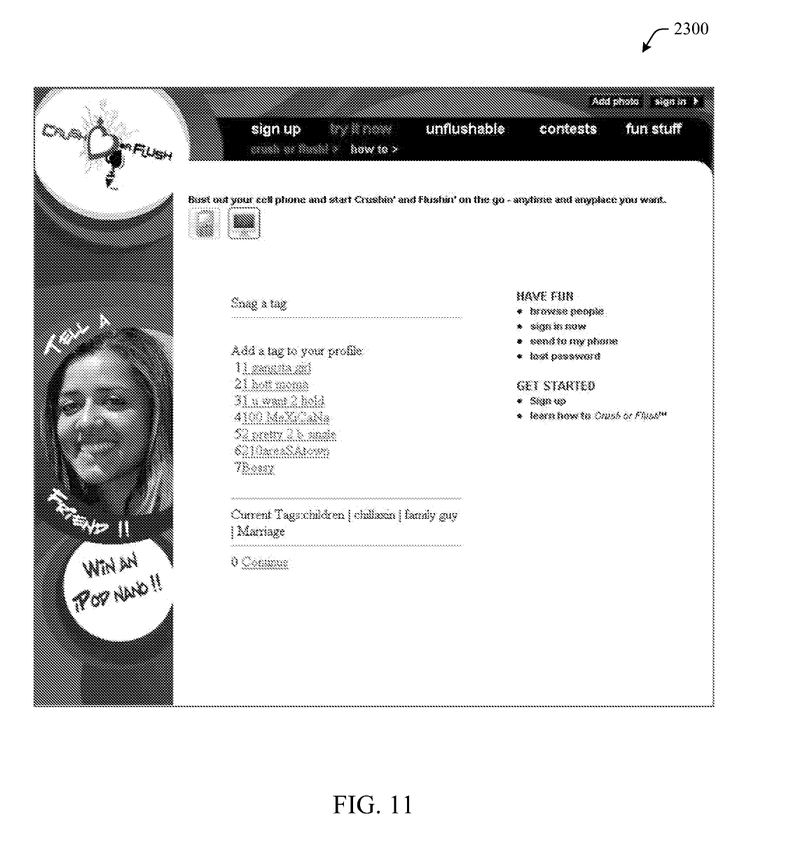

FIGS. 10 and 11 illustrate example GUI screen shots in accordance with aspects of the components and sub-components described supra. Essentially, the figures illustrate example interfaces that illustrate the feature, functions and benefits described above. It is to be appreciated that these example GUIs are provided to add perspective to the innovation and are not intended to limit the scope of the innovation in any way.

Referring initially to FIG. 10, an example screen shot of a candidate profile is shown. As described above, profiles can be queried based upon most any criteria as desired. One such mechanisms of query is based upon tag identification. Here, a user can specify a word or phrase by which to search. Accordingly, profiles which include the queried tag can be returned.

With reference to FIG. 10, tags such as ‘1 gansta girl,’ ‘1 hott moma,’ 1 u want 2 hold,’ ‘100 MeXiCaNa,’ ‘2 pretty 2 b single,’ ‘210areaSAtown,’ and ‘Bossy’ are shown in connection with this example profile. Accordingly, a user can choose to ‘snag’ any one or a group of tags by choosing option 8, ‘snag-a-tag.’

FIG. 11 illustrates an example screen shot of a snag-a-tag GUI in accordance with an aspect of the innovation. As shown, a numbered list of tags can be displayed for selection by a user. Once a tag is selected, it can be incorporated into a user profile as desired. It is to be understood that most any configuration of tags can be employed without departing from the spirit and/or scope of the innovation. For instance, while the example of FIG. 11 employs sequentially numbered tags, other examples can include alphabetized lists, radio buttons or the like to assist in user selection. Essentially, it is to be understood that most any selection tool (e.g., keyboard, navigational device (mouse), voice commands) can be used to select tags from an available list.

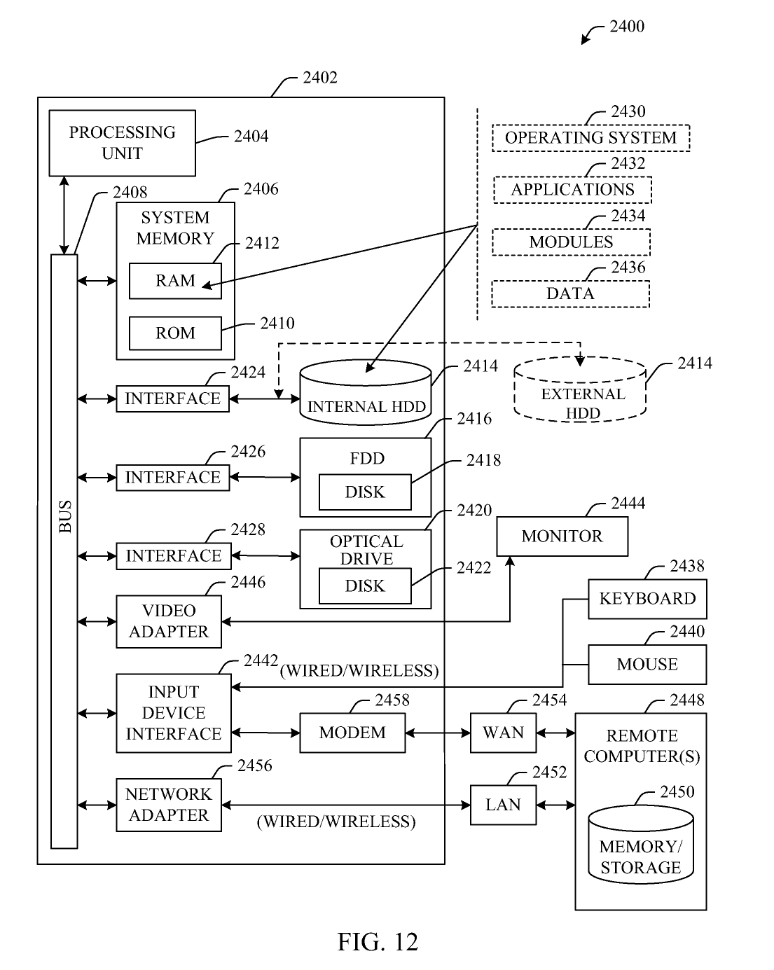

Referring now to FIG. 12, there is illustrated a block diagram of a computer operable to execute the disclosed architecture. In order to provide additional context for various aspects of the subject innovation, FIG. 12 and the following discussion are intended to provide a brief, general description of a suitable computing environment 1200 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term ‘modulated data signal’ means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 12, the example environment 1200 for implementing various aspects of the innovation includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the innovation.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is appreciated that the innovation can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers, etc.

The computer 1202 may operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1252 through a wired and/or wireless communication network interface or adapter 1256. The adapter 1256 may facilitate wired or wireless communication to the LAN 1252, which may also include a wireless access point disposed thereon for communicating with the wireless adapter 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 via the serial port interface 1242. In a networked environment, program modules depicted relative to the computer 1202, or portions thereof, can be stored in the remote memory/storage device 1250. It will be appreciated that the network connections shown are example and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

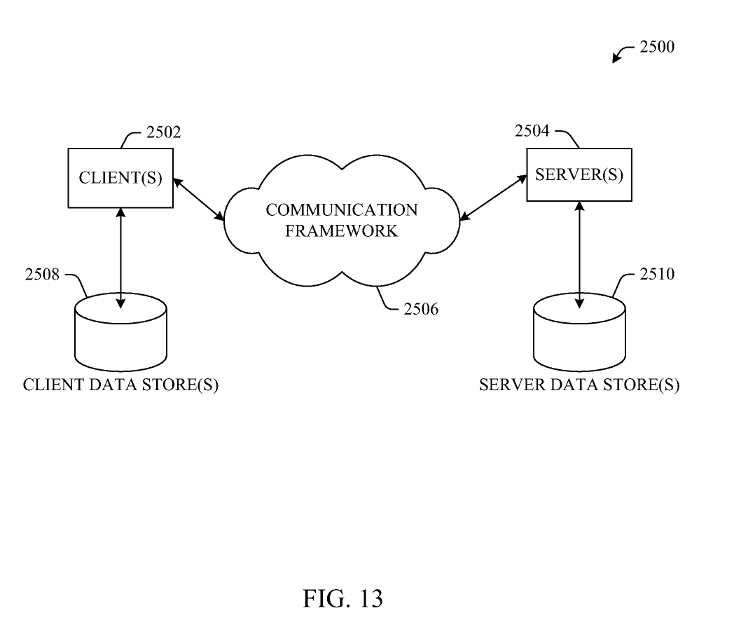

Referring now to FIG. 13, there is illustrated a schematic block diagram of an example computing environment 1300 in accordance with the subject innovation. The system 1300 includes one or more client(s) 1302. The client(s) 1302 can be hardware and/or software (e.g., threads, processes, computing devices). The client(s) 1302 can house cookie(s) and/or associated contextual information by employing the innovation, for example.

The system 1300 also includes one or more server(s) 1304. The server(s) 1304 can also be hardware and/or software (e.g., threads, processes, computing devices). The servers 1304 can house threads to perform transformations by employing the innovation, for example. One possible communication between a client 1302 and a server 1304 can be in the form of a data packet adapted to be transmitted between two or more computer processes. The data packet may include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term ‘includes’ is used in either the detailed description or the claims, such term is intended to be inclusive in a manner similar to the term ‘comprising’ as ‘comprising’ is interpreted when employed as a transitional word in a claim.

What is claimed is:

1. A system that facilitates profile management, comprising:
a social interaction network that renders a plurality of profiles in response to a query, wherein each of the profiles has a plurality of tags related thereto; and
a tag management component provides a user ability to snag a subset of the plurality of tags, wherein the subset is automatically added to the user's profile.

2. The system of claim 1, further comprising a locator component that retrieves the plurality of tags based upon the query.

3. The system of claim 2, wherein the tags are one of community tags or certified tags.

4. The system of claim 2, further comprising a tag selection component that enables the user to choose the subset of the tags; wherein the subset of the tags is added to the user's profile.

5. The system of claim 4, further comprising a snag-a-tag component that renders a list of the plurality of tags to the user; wherein the list includes one of a numbered list, a plurality of check boxes, or a plurality of radio buttons.

6. The system of claim 1, further comprising a tag clustering component that automatically includes related tags in the plurality of tags.

7. The system of claim 1, further comprising a common tag identification component that identifies a plurality of tags common to any two of the plurality of profiles.

8. The system of claim 1, further comprising a unique tag identification component that identifies a unique tag in based upon the plurality of tags related to the plurality of profiles.

9. The system of claim 1, further comprising a tag certification component that regulates use of certified tags.

10. The system of claim 9, wherein the tag certification component prompts a certification approval process, wherein upon successful approval, the tag certification component grants access right to the user.

11. The system of claim 1, further comprising one of a rules-based logic component or a machine learning & reasoning component that automates functionality on behalf of the user.

12. A computer-implemented method of managing descriptive information related to a social networking service, comprising:
locating a profile of a candidate based upon a query;
identifying a plurality of tags included within the profile;
identifying a subset of the plurality of tags; and
snagging the subset of the plurality of tags for incorporation into a personal profile.

13. The computer-implemented method of claim 12, further comprising defining the query.

14. The computer-implemented method of claim 12, further comprising displaying a list of the plurality of tags to a user, wherein the user selects the subset from the list.

15. The computer-implemented method of claim 14, further comprising clustering the plurality of tags based upon the query, wherein the list includes a subset of the clustered tags.

16. The computer-implemented method of claim 14, further comprising identifying a plurality of common tags based upon the plurality of tags included within the profile, wherein the list includes the plurality of common tags.

17. The computer-implemented method of claim 14, further comprising identifying a plurality of unique tags based upon the plurality of tags included within the profile, wherein the list includes the plurality of unique tags.

18. A social interaction system, comprising.
means for identifying a plurality of profiles, wherein each of the profiles includes at least one tag;
means for displaying a plurality of tags that correspond to the plurality of profiles; and
means for snagging a subset of the plurality of tags for incorporation into a user profile.

19. The system of claim 18, wherein the means for identifying the plurality of tags includes at least one of a tag clustering means, a common tag identification means or a unique tag identification means.

20. The system of claim 19, further comprising means for certifying at least one of the subset of the plurality of tags prior to incorporation into the user profile.
